(19) United States
(12) Patent Application Publication
(10) Pub. No.: US 2022/0227454 A1
(43) Pub. Date: Jul. 21, 2022

(54) INTELLIGENT ELECTRIC BICYCLE CONTROL SYSTEM

(71) Applicants: SERHII VICTOROVYCH DENYSENKO, Kyivska obl. (UA); Daniel TONKOPIY, Kyivska obl. (UA)

(72) Inventors: SERHII VICTOROVYCH DENYSENKO, Kyivska obl. (UA); Daniel TONKOPIY, Kyivska obl. (UA)

(21) Appl. No.: 17/610,543

(22) PCT Filed: Apr. 21, 2020
(86) PCT No.: PCT/UA2020/000045

§ 371 Date: Nov. 11, 2021

(30) Foreign Application Priority Data
May 24, 2019 (UA) U 2019 05663

(51) Int. Cl. B62M 6/45

(52) U.S. Cl. CPC B62M 6/45; B62K 23/04

(57) ABSTRACT

An invention relates to the field of electronic vehicle control systems, in particular electric bicycles intended for heavy loads. The intelligent electronic bicycle control system includes a controller to control electric motor, a throttle handle, a sensor, a battery, a communication module for transferring data on a movement and condition of electric components and to exchange data with a mobile application and a remote control, an alarm, a light controller to control light, turns and stop signals and audio signal, a controller for collisions prevention and a bicycle computer to display the main parameters of the system, and all elements are connected by a bus. Enhanced functionality.

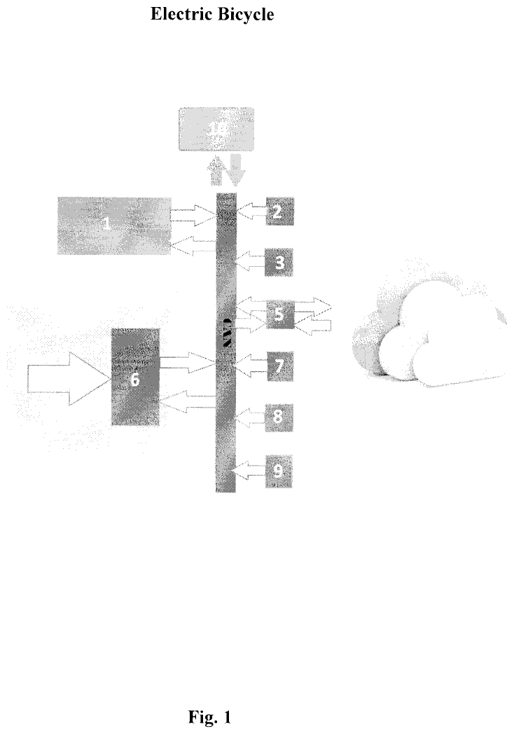

### CROSS REFERENCE TO RELATED APPLICATION

This application is a national stage entry of PCT/UA2020/000045 filed Apr. 21, 2020, under the International Convention and claiming priority over Ukraine Patent Application No. u 2019 05663 filed May 24, 2019.

### FIELD OF THE INVENTION

Invention belongs to the field of electronic systems of the transport means control, including electric bicycles, meant for large loads.

### BACKGROUND OF THE INVENTION

In contrast to conventional bicycles, and also electric bicycles with low mileage, the operation of electric bicycle with high mileage causes some difficulties. For example, the much larger mass and large capacity of the lithium battery carry additional risks for the user. Also, due to the powerful motor, electric bicycles can reach significant speeds. Therefore, all systems of electric bicycles must operate consistently and reliably, if possible, to prevent user on possible dangerous situations and rejection of critical components, which can lead to the injury of the user. Besides electric bicycles use rather expensive components, the destruction of which can lead to expensive repairs.

Considering high speed, power, complexity of electronic components there are more popular electric control systems with programmable controllers of a motor control, which, depending on the model, allow to modify various parameters of the motor, namely from the value of the battery and phase currents to the corners of the advance phase and weakening of the field, they are connected with a computer by using a cable or with a smartphone/tablet by using Bluetooth, can be designed for a wide range of characteristics, which gives the opportunity to design a rather flexible system from existing components on the market and receive a variety of options for solution of various technical problems.

It is known from the art controller «24V/250W-Al » for electric bicycles, designed to regulate the speed of DC current electric motors which has a nominal voltage of 24V and in a short mode performs the power of the electric motor to 360 W.

It is recommended for use with electric motors of DC current 24V/250 W [https://motovelo.com.ua/kontroller-24v250w-k-jeldv-postojannogo-toka.html]. It is also known a controller of “Kelly Controls Inc” for electric bicycles, that controls the electric motor [https://kellycontroller.com/].

The downside of such decisions is the fact that the controller controls only the electric motor and is programmed exclusively for specific characteristics of each individual motor, but other equipment, such as BMS, charge controller, various sensors—operate independently from each other.

It is also known a function and quality controller “Evel Eco 48-72v36A 1500 W 15 mosfet”, by means of which the control system support functions to reverse, no-touch mode, recuperation, 3 modes of speed (50/100/130%), cruise control, alarm connect with an antitheft system, the possibility of changing the direction of rotation of the motor and the supply voltage (48, 60 or 72V) [https://evel.ua/catalog/controllers/controller-evel-eco-48-72v36a-1500w-15-mosfet/]. However, this controller is intended only for light electric bicycle.

More progressive is considered transitional standardized general-purpose platforms on the basis of the technology of personal computers (PC), which we can see in industrial management systems. One of the main reasons for this transition was the desire of users and manufacturers to integrate their information technology (IT) system with an industrial automation system based on a single through platform. Embed IT in automation system goes on field level, sensors and executing devices of which are becoming more intelligent, and also on the control level, where to replace traditional PLC-controller a technology of embedded PCs is used.

In addition to the gradual convergence of IT-systems with systems of industrial automation, additional factors for the transition to PC-compatible architecture industrial management systems is the use of Web services and distribution networks of industrial Ethernet.

Closest known form the art to the invention, which is claimed, is a system with a concentrator controller “Intel System Controller Hub (Intel®SCH)”, developed by Intel Corp. The controller contains a memory controller, a graphics controller and a single-crystal I/O controller, which is connected to a processor on a 400/533-MHz/system bus [http://wwwfussianelectronicssu/leader-r/review/31584/doc/46334/]. The system has quite wide functional capabilities. The disadvantage of this solution is also the relatively large size of the controller which is unacceptable for mobile power systems.

### Object and Summary of the Invention

As a basis for invention is a task to create intelligent electric bicycle control system with broad functional capabilities.

The problem is solved by the fact that the in intelligent electric bicycle control system, which includes a controller for controlling the motor of the electric bicycle, according to the invention, contains a throttle handle, a sensor, a battery, a communication module for transmitting data on the movement and condition of the components of the electric bicycle and for data exchanging with a mobile application and remote control, alarm, light controller for light control, turn and stop signals and sound signal, collision avoidance controller and bicycle computer for display of the main parameters of the system, wherein all the elements including the controller, are connected by the bus.

As the controller it is used a single board real time computer, which is designed on a basis of ARM architecture microcontroller and includes I/O devices for sensors and executive devices.

A bicycle computer is a device with an LCD screen.

The intelligent system continuously monitors and records the parameters of individual components, warns about critical situations and errors in real time, but also prevents possible collision during a traffic or when the automobile is moving behind cyclists.

Intelligent system can perform remote registration of all main parameters and geographical location using a GPS sensor, Wi-Fi access points, cellular etc., to help maximize optimal pass route, to prevent theft and to warn the user if any of the important parameters are outside the acceptable limits. The system must also report that one or another component requires regular maintenance or replacement. Also, companies engaged in the delivery of goods can use such key indicators as itineraries, mileage, a battery charge for the cost counting of operation of the vehicle.

Controller—single board real time computer, which is designed on basis of ARM architecture microcontroller, in contrast to the prototype a significant number of I/O devices and executive devices, uses energy-saving technologies, but also has the possibility of reliable operation under adverse conditions: a wide range of temperatures, high humidity, strong electromagnetic interference, vibrations and more. It is possible to lay in its software the characteristics of the most acceptable variants of the equipment.

The coordinated operation of all the components of the controller allows to achieve a maximum safety and comfortable operation of the electric bicycle, as well as maximize the travel distance from a single charge of the battery.

### BRIEF DESCRIPTION OF DRAWINGS

The invention is explained by the schematic FIGURE of an intelligent electric bicycle control system.

The intelligent system includes a controller (I) to control electric bicycle engine (single board real time computer. which is designed on the basis of ARM architecture microcontroller and includes I/O devices for sensors and executive devices), the throttle handle (2), a sensor (3), the battery (4), the connection module (5) for transferring data on the movement and electric bicycles components status, as well as to exchange data with the mobile application and the remote control, the alarm (7), the light controller (8) to control light, turns and stop signals, and also audio signal, the controller (9) for collisions prevention and the bicycle computer (10), which is a device with an LCD screen to display the main indicators of the system which are connected by CAN bus. The intelligent electric bicycle control system, which consists of separated electronic modules with different functions, combined with consistent CAN bus, controlled and guided by the single-board computer on the basis of ARM architecture to work as a single system.

Controller (I) (for example “BLDC”) I is designed to control bicycle motor. It takes control commands and reverse connection from multiple sensors and regulators: mode switchers (not shown), the throttle handle (2), the sensor (3) (for example “PAS”). The sensor (3) and data from other sensors allow the most efficient use of the battery (4) and facilitate the efforts of cyclist.

Communication module (5) is intended for the exchange of data on the movement and electric bicycle components status, as well as to exchange data with the mobile application and the remote control. The main module of the battery is a collection of series parallel connected elements on the basis of lithium and control electronics, which performs a battery balancing, energy recovery when braking (recuperation), monitors compliance with best thermal regime of the battery and manages the process of optimal charging and discharging of the battery (6) (BMS).

The alarm (7) performs protective functions. In fact, it is the antitheft system that blocks the bicycle's electrical drive and turns on the siren when someone tries to steal it. This module also transmits to the user emergency messages via the communication module (5) using different communication channels.

The light controller (8) is designed to control light, turns and stop signals, as well as a sound signal, integrated into the overall system by using CAN bus. The user can also control the light in the manual mode. Other modules can also control the light signals in automatic mode in certain situations. For example, if the cyclist is entering the turn, tilting the wheel. gyro sensors (accelerometer) gives a command to the rotation indicator which automatically turns on and off.

The controller (9) for collisions prevention helps to prevent collisions and hits. To do so, it uses information from a front-facing radar microwave sensor and a rear radar sensor, or an optical device, depending on the modification. If another vehicle approaches to the dangerous distance from the back on a speed, a user receives a voice warning about the potential dangers. Or, for example, the cyclist, who is moving on the road approaches an obstacles or another vehicle.

The controller (9) for collisions prevention with the use of front-facing radar sensor receives information about the distance to the obstacle and the speed of convergence, making calculations. If the calculations show that it is necessary to slow down or make an emergency brake, the corresponding command is transmitted to the controller (I), and the speed of the electric bicycle is automatically reduced.

The bicycle computer (10), which is a device with an LCD screen is used to display the main indicators of the system, as well as to make some changes. Its main task is to provide the user with a “user-friendly” graphical interface. The bicycle computer (10) not is a critical component of the system, and in case of its failure or damage a user can continue the movement.

Under real conditions, the system is configured as separate modules connected by a power supply unit and a bus. The modules are located in different parts of the electric bicycle, in the internal cavities. The control instruments are located mostly on the steering wheel and on the external parts of the frame. For connecting modules and sensors sealed connectors are used, so as in the automotive industry. The module of the controller (I) is highly heated during workloads, so it is made of aluminum radiator case and placed externally on the electric bicycle frame.

1. An intelligent electric bicycle control system comprising:
a controller for an electric motor,
a throttle handle,
a sensor,
a battery,
a communication module for transferring data on the movement and status electric components status to exchange the data with a mobile application and remote control,
an alarm,
a light controller to control light, turns and stop signals and sound signal,
a controller for collisions prevention and a bicycle computer to display the main parameters of the system, and all elements including the controller, are connected by a bus.

2. The intelligent electric bicycle control system of claim 1, wherein the controller uses a single board real time computer, which is designed on basis of ARM architecture microcontroller and includes input/output devices for sensors and executive devices.

3. The intelligent system of claim 1, wherein the bicycle computers is a device with an LCD screen.
